(19) United States
(12) Patent Application Publication
(10) Pub. No.: US 2022/0282426 A1
(43) Pub. Date: Sep. 8, 2022

(54) CLEANING DEVICE FOR A SUCTION ROLLER AND METHOD FOR CLEANING A SUCTION ROLLER

(71) Applicant: Voith Patent GmbH, Heidenheim (DE)

(72) Inventors: Dominik Appel, Giengen (DE); Jose Luiz Campos Souza, Heidenheim (DE)

(21) Appl. No.: 17/631,945

(22) PCT Filed: May 19, 2020
(86) PCT No.: PCT/EP2020/063881

§ 371 Date: Feb. 1, 2022

(30) Foreign Application Priority Data
Aug. 1, 2019 (DE) 10 2019 120 818.1

(51) Int. Cl. D21F 1/34; B08B 3/02; D21F 3/10; B05B 1/08; B05B 1/20

(52) U.S. Cl. CPC D21F 1/345; B08B 3/02; D21F 3/10; B05B 1/08; B05B 1/202

(57) ABSTRACT

A cleaning device, in particular for a suction roller, for a machine for producing or processing a fibrous web, includes a distribution line and a number of cleaning nozzles which can be supplied with a cleaning fluid via the distribution line. At least one cleaning nozzle, in particular all of the cleaning nozzles, are in the form of oscillating nozzles. A suction roller and a method for cleaning a suction roller are also provided.

The invention relates to a cleaning device, in particular for a suction roller for a machine for producing or processing a fibrous web as claimed in the pre-characterizing clause of claim 1, and to a suction roller as claimed in the pre-characterizing clause of claim 11, and to a method for cleaning a suction roller as claimed in the pre-characterizing clause of claim 13.

Suction rollers or blowing rollers are used at many points in the production of paper, cardboard, or tissue products, and also in the production of nonwoven products. These rollers have a perforated roller shell. When suction rollers are in operation, a vacuum is applied such that air/water or other streams of fluid are sucked through the perforations of the roller shell. Similarly, an elevated pressure is applied in the case of blowing rollers such that a stream of fluid is blown through the roller shell.

The fluid streams which pass through the perforations of the suction roller usually carry a greater or lesser amount of dirt with them. The dirt can here be mineral constituents such as, for example, limestone in waste water, or alternatively particles of mineral filling material from the paper, or alternatively fibers and fines from the paper or nonwoven product. This dirt content gradually builds up on the edges of the perforations and completely or partially clogs these perforations.

Even only partially clogged perforations of the roller shell cause disruption to the production process. The effects are highly dependent on the purpose of the suction and blowing rollers. Clogged perforations can, for example, cause web flutter in the case of a suction roller for guiding or stabilizing the fibrous web. The dewatering capacity decreases in the case of suction press rollers. Quality parameters of the web such as, for example, the moisture profile can also be affected in particular owing to an uneven contamination of the perforations in the transverse direction of the roller.

A possible remedy for this is to subject the suction roller to a cleaning procedure at regular intervals. However, this entails the production machine being halted and the complex disassembly and installation of the roller, as a result of which the operator incurs high costs.

In the prior art, in particular DE 10 2008 002 259, it was therefore proposed to provide the suction roller with a cleaning device. A cleaning head is here installed inside the roller and has a number of nozzles from which a cleaning fluid is sprayed through the perforations at a certain pressure in order to remove the impurities.

In the case of conventional suction rollers in the paper or nonwoven industry, the individual perforations have a very small diameter of a few millimeters. Several hundred such holes, which can additionally be offset relative to one another in so-called drilling patterns, are therefore arranged over the width of a suction roller, which can be 10 m or more. It is thus barely possible from a technical and economic point of view to use an individual cleaning nozzle for each hole. DE 10 2008 002 259 solves this problem by the cleaning head being configured so that it is movable in the roller. A certain region of the width of the roller shell can be cleaned by an individual nozzle by the oscillation of the cleaning head.

A disadvantage of this solution, however, is that in particular the required mechanism for moving the cleaning head is very complex and expensive. In addition, the required mechanical and hydraulic components are always prone to failure and necessitate regular maintenance. In addition, this cleaning system requires a relatively large amount of structural space. This means that such a cleaning system cannot be used in suction rollers with a small diameter.

The object of the present invention is therefore to propose a cleaning device which overcomes the problems from the prior art, and also a suction roller and a cleaning method for such a suction roller.

The objects are completely achieved by a cleaning device as claimed in the characterizing clause of claim 1, a suction roller as claimed in the characterizing clause of claim 11, and a method for cleaning a suction roller as claimed in the characterizing clause of claim 13.

For reasons of readability, the invention is explained with the example of a suction roller. Unless explicitly described otherwise, it is intended that blowing rollers are also at all times included here.

With regard to the cleaning device, the object is achieved by a cleaning device in particular for a suction roller for a machine for producing or processing a fibrous web, wherein the cleaning device comprises a distribution line and a number of cleaning nozzles which can be supplied with a cleaning fluid via the distribution line. According to the invention, it is provided that at least one cleaning nozzle and in particular all the cleaning nozzles is/are designed as oscillating nozzles. Advantageous embodiments are described in the dependent claims.

It is clear to a person skilled in the art that the cleaning nozzles must be arranged in a cleaning device of this type such that the emerging fluid jet strikes the object to be cleaned, for example the roller shell or the perforations.

The term “fluid oscillator” has been known for a long time to cover devices by means of which a fluid jet can be generated which oscillates within a plane and thus generates a fan-shaped pattern. Oscillators of this type are described, for example, in the European patent EP 0 007 950 and the documents quoted therein. In contrast to a classic flat fan nozzle, the jet itself is here not fan-shaped and instead can be essentially a spot jet. The jet can be caused to oscillate back and forth by a suitable design of the nozzle geometry. As the explanations in EP 0 007 950 (on which greater detail will be given below) show, no moving parts at all are necessary for this, as a result of which the oscillator has very little wear and is low-maintenance.

Such fluid oscillators have previously been used mainly in sectors such as, for example, the automobile industry. The company Bowles Fluidics (www.bowlesfluidics.com) sells such oscillators as, for example, wiper nozzles for headlights and windshields. The inventors have recognized that such an oscillator is surprisingly also suited to being used to clean suction rollers. It has been shown here that such an oscillator has three properties which make it suitable for use in a cleaning device in a certain region of the roller shell, in particular in the cross direction, and can consequently clean a plurality of neighboring perforations. In contrast to the cleaning devices known from the prior art, this happens here without there being any need for a mechanism or a hydraulic device to move the nozzle. It has furthermore been shown that the energy of the jet or the fluid is sufficiently high when it strikes the roller shell to obtain an adequate cleaning effect. Lastly, oscillators of this type can be manufactured so that they are very compact. The structural size of the cleaning device can consequently be kept considerably smaller than in the prior art. It is thus possible to satisfy an old requirement of the producer and to manufacture such a cleaning device also for suction rollers with very small diameters or a particularly small gap between the suction box and the shell.

The oscillating nozzles are advantageously oriented such that the oscillation of the jet takes place in the same direction for all the oscillating nozzles or these directions differ only by less than 10°. When installing such a cleaning device in a suction roller or in or on a different unit of a fibrous material machine, this oscillation can advantageously take place in a cross direction.

The cleaning devices according to different aspects of the present invention are, as described, particularly suited for cleaning suction and blowing rollers. However, they can also advantageously be used to clean or moisten other parts of a paper or nonwoven machine. The cleaning or conditioning of clothing, in particular screens or felts, can be mentioned here by way of example.

It can be provided in preferred embodiments that, when it oscillates, the jet emitted from the oscillating nozzles covers an angle within the range between 90° and 170°, preferably between 110° and 130°, particularly preferably 120°.

In an advantageous embodiment, a first quantity and a second quantity of oscillating nozzles are provided in the cleaning device, wherein the exit angles of the plane of the jet of the first quantity and the second quantity differ from each other. It can in particular be provided that respective oscillating nozzles of the first and the second quantity are arranged alternately.

The advantage of differently directed jets is that they strike the roller shell at different circumferential positions. It is consequently possible to position neighboring cleaning nozzles in principle as close to one another as desired without there being any risk that the emitted fluid jets intersect and consequently possibly reduce the cleaning effect because the jet of the neighboring nozzle in each case always strikes the roller shell slightly above or below. It has proven to be advantageous here if the exit angles of the plane of the jet of the first quantity and the second quantity differ by more than 2°, in particular between 5° and 25°.

Where necessary, third, fourth, etc. exit angles can also be provided according to the application.

Unless described otherwise, it is intended that the exit angle is here determined as the angle which the plane of the jet encloses with the vertical. In the case of the oscillators known from the prior art, the flow profile is straight, i.e. the direction in which the fluid flows into the oscillator lies within the plane of the oscillating jet. Different exit angles of the plane of the jet can be produced by means of oscillators of this type by the inflow direction differing accordingly. The distribution line can advantageously be a cylindrical or essentially cylindrical tube. The different exit angles can be produced by the above straight oscillators being installed in the distribution line at different angles. Such a design can, however, result in an increased structural size for the cleaning device. Moreover, it would be desirable from a manufacturing point of view if all the cleaning nozzles can be introduced into the distribution line in a row and at the same angle. It would thus be very desirable if the deflection of the plane of the jet could take place as early as in the nozzle itself. Thus, if a more compact structure could be obtained, the described cleaning device could also be used in confined installation conditions. However, this cannot be achieved simply by curving the known oscillator geometries because it would then not be possible to form an oscillating jet.

In order to solve this problem, the known fluid oscillators have been improved by the inventors in such a way that the plane of the jet is deflected as early as inside the nozzle but the oscillating jet is nevertheless preserved. These angled oscillating nozzles in their own right represent a further invention and are described in more detail below in the course of the application.

As mentioned above, it can be advantageous for the cleaning device if at least some and in particular all the oscillating nozzles have an angled design such the plane of the jet is deflected inside the nozzle.

It can happen, for example because of impurities in the cleaning fluid, that the cleaning nozzles, in particular the oscillating cleaning nozzles, themselves become clogged after a certain period of time. In addition, damage can occur to the cleaning nozzles because of wear during operation. In contrast to the complicated maintenance of the cleaning device described in the prior art, the cleaning nozzles in the cleaning device according to an aspect of the invention can be replaced easily. The cleaning nozzles can be replaced particularly easily if the cleaning nozzles are connected to the distribution line via a detachable connection, in particular a screw or plug connection.

In an advantageous embodiment, the cleaning nozzles are attached next to one another on the distribution line, wherein the gap between two neighboring cleaning nozzles is advantageously less than 500 mm and is, for example, between 150 mm and 350 mm. It can be advantageous here if the nozzles are not all evenly spaced apart. It can in particular be advantageous, in order to obtain an even cleaning effect, if the nozzles are arranged in pairs and the gap l_{A} between the nozzles in a pair is less than the gap l_{B} from the next pair. More detail about this is explained with the aid of the drawings. Alternatively, it can, however, also be expedient if the cleaning nozzles are provided evenly along the distribution line.

With regard to the suction roller, the object is achieved by a suction roller for a machine for producing or processing a fibrous web, wherein the suction roller comprises at least one cleaning device according to an aspect of the invention.

Whilst the cleaning device can in principle also be attached outside the suction roller, it is usually advantageous if the cleaning device is arranged inside the suction roller.

If the cleaning device is arranged inside a suction roller, the width of the region covered by the oscillating jet of a nozzle depends on the oscillation angle θW and the gap between the oscillating nozzle and the shell of the suction roller. This width is calculated by the formula:

$${b}_{S} = 2 {l}_{d} tan \frac{θ W}{2}$$

It is advantageous if an oscillating nozzle of a quantity (for example, the first quantity or the second quantity) is removed from the next nozzle of this quantity by this gap b_{S} or more in order to prevent the oscillating jets from being affected by the jets of the neighboring nozzles.

The invention further comprises a method for cleaning a suction roller according to an aspect of the invention. A fluid, in particular spraying water, can here be applied to the cleaning device, wherein the fluid has a pressure of less than 40 bar, in particular less than 10 bar, preferably between 1 and 5 bar. At pressures above 40 bar, the material of the cleaning device is very highly stressed, as a result of which wear quickly occurs. An adequate cleaning effect can, however, also be obtained in many cases at a lower pressure, specifically also between 1 bar and 5 bar.

It can furthermore be advantageous if less than 20 l/min/m, in particular between 9 l/min/m and 11 l/min/m, are used for the cleaning. This low water consumption is economically and ecologically desirable and at the same time makes possible a good cleaning effect. However, specifically if operating at higher fluid pressures, in particular above 5 bar, it can also be helpful to carry out cleaning with larger amounts of fluid, for example 30 l/min/m, 40 l/min/m, or more.

The cleaning method described can take place either continuously during the operation of the suction roller or only at discrete cleaning intervals which can also occur when the machine is halted.

As already mentioned above, the angled oscillating nozzles represent a further invention which can be used both for a cleaning device according to an aspect of the preceding invention and also be suited for a plurality of other applications.

Starting from the known fluid oscillators, for example EP 0 007 950, the object of the further invention is to provide an oscillator, in particular an oscillating nozzle, in which the direction of the fluid entering the oscillator does not lie within the plane of the oscillating jet.

This object is achieved by an oscillating nozzle, in particular for a cleaning device according to an aspect of the first invention, wherein the oscillating nozzle comprises a fluid oscillator and the oscillating nozzle has an angled design such that the plane of the jet is deflected inside the nozzle, characterized in that the deflection takes place downstream from the fluid oscillator.

The fluid oscillator in the angled nozzle often comprises, downstream from the oscillator inlet, an oscillation chamber and usually one or two return ducts. The oscillation of the fluid jet is induced by the shape and arrangement of the latter and it then leaves the fluid oscillator again at an outlet. Whilst oscillators configured in this way are advantageous, the invention is not, however, limited thereto.

Attempts at angling the nozzle in the region of the oscillator often fail because the formation of the oscillation is prevented or hampered as a result. The inventors thus consider it advantageous to angle the jet after it has exited the oscillator.

In an advantageous embodiment, the nozzle geometry is configured such that, downstream from the oscillation chamber, the fluid is conveyed through two ducts separated by an island. This region is referred to as the wake region. The deflection of the plane of the jet preferably takes place in this wake region. The ducts can advantageously be symmetrical. It can also be advantageous if the width of the ducts remains constant, or at least largely constant, over their course. It should in particular be understood here that the duct width in the start and end regions can differ from the width in the remaining region. Such a design has proven to be very advantageous because a very wide range of angles can be obtained in this way without affecting the efficiency of the oscillator. The inventors have discovered that providing a wake region and positioning the deflection in this wake region is particularly advantageous. Nozzles of the described type can namely, despite the complicated inner structure of the oscillator or the whole flow chamber, be produced very simply and cost-effectively using additive processes (three-D printing). The nozzles can here be produced from a plurality of materials, for example metals and/or polymer materials. However, a disadvantage of such additively manufactured nozzles is that the inner surfaces of the flow chamber usually have a relatively high degree of roughness and it is difficult to impossible to finish the inside of the nozzle. This internal roughness means that, when a nozzle without a wake region is used, a majority of the fluid is discharged in the region of the turning points of the oscillating jet. Consequently, in practise only limited opening angles can be obtained because otherwise there is no longer sufficient fluid discharged in the regions between the turning points. A marked homogenization of the fluid discharge can be achieved by means of the wake region, preferably with the described annular shape, situated downstream. It has additionally surprisingly been shown that the nozzle can be angled in this wake region within wide angular ranges without the formation of the oscillation being affected as a result.

It can thus be provided in particularly advantageous embodiments that the plane of the jet is deflected by an angle between 1° and 90°, in particular between 5° and 45°.

It can furthermore be advantageous if at least one lip is provided at the exit from the oscillating nozzle downstream from the outlet opening in order to prevent the jet from widening out perpendicular to the plane of the jet. It can be very especially advantageous if two lips are provided. The widening out of the jet both upward and downward can consequently be prevented.

The length of the lip can advantageously be at least three times as long as the width of the oscillator inlet.

Even though it is clear to a person skilled in the art from the above, it should at this point be explained again that the term “inside the nozzle”, i.e. the region in which the deflection of the plane of the jet takes place, refers to the region between the inlet, in particular between the oscillator inlet and the outlet opening. The flow chamber, with the oscillator and the wake region, is situated there. Optionally provided lips are accordingly not part of the inside of the nozzle. The lip or lips is or are usually not angled or curved and instead has or have a straight design. Angling or curving the lips is also not necessary for deflecting the jet because the angling happens earlier inside the nozzle. Nevertheless, in some cases it can be expedient to provide additional curving or additional angling in the region of the lips. Such designs are also included in the present invention.

It can be provided in preferred embodiments that the emerging jet covers an angle within the range between 90° and 170°, preferably between 110° and 130°, particularly preferably 120°.

Depending on the desired application or availability, the angled oscillating nozzle can be produced from a plurality of materials. Included are both metals such as steel, aluminum, etc. and plastics such as, for example, a polyamide, in particular PA 12, or a polyethylene.

In preferred embodiments, the nozzle can have a one-piece design. A further large advantage is that these nozzles can also be produced by means of additive processes.

Further advantageous embodiments of the invention are explained with the aid of exemplary embodiments and with reference to the drawings. The features mentioned can advantageously be implemented not only in the combination illustrated but can also individually be combined with one another. In detail, in the drawings:

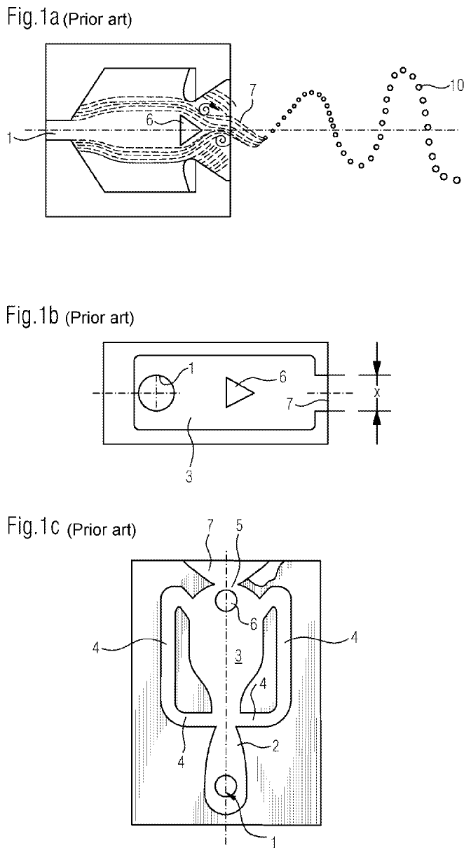

FIGS. 1a, 1b, and 1c show examples of fluid oscillators from the prior art.

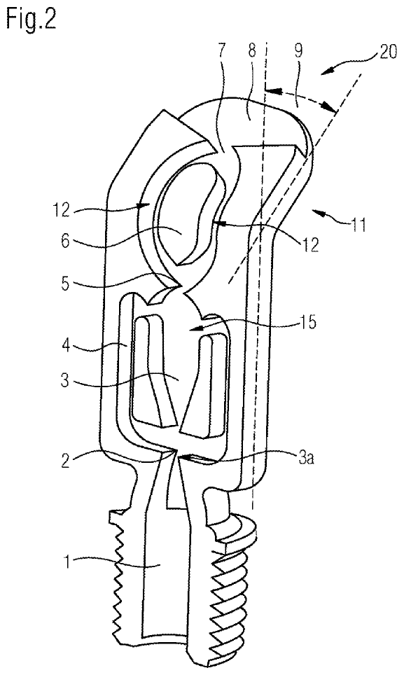

FIG. 2 shows schematically a section through the structure of an angled oscillating nozzle according to an aspect of the invention.

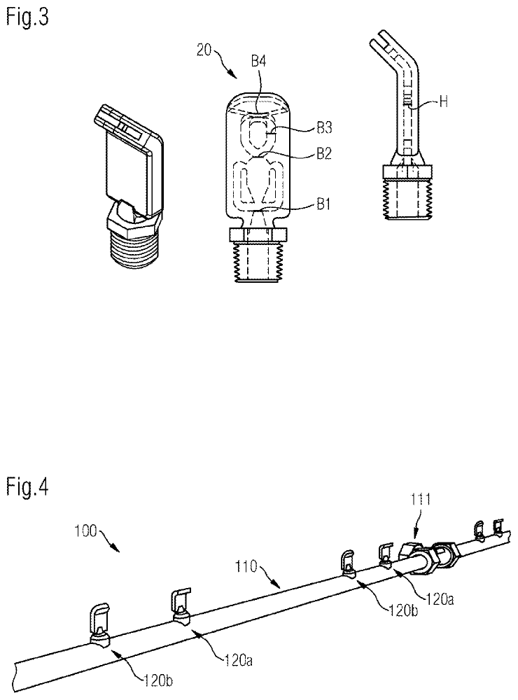

FIG. 3 shows schematic views of an angled oscillating nozzle according to an aspect of the invention.

FIG. 4 shows schematically a portion of a cleaning device according to another aspect of the invention.

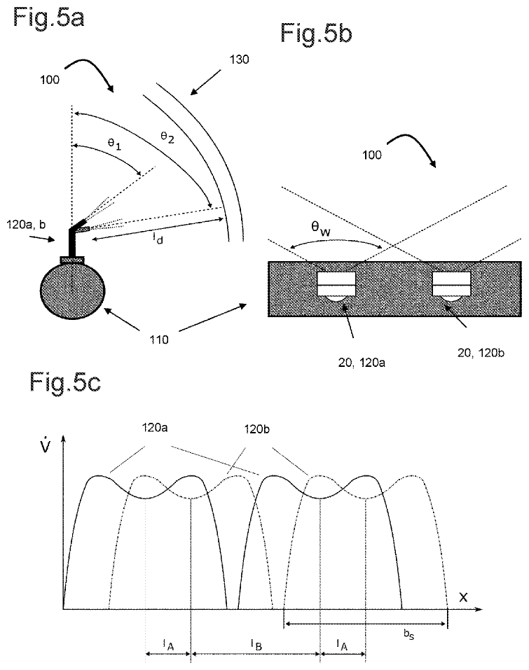

FIGS. 5a, 5b, and 5c show details of a cleaning device according to an aspect of the invention.

The drawings are described in more detail below.

FIGS. 1a, 1b, and 1c show schematically different embodiments of fluid oscillators known from the prior art which are suited for use in oscillating nozzles 20 according to different aspects of the present invention. However, the present inventions are not limited to these designs of the fluid oscillators. In general, all types of fluid oscillators are suited. The fluid can enter the flow space through an inlet 1. As shown in FIG. 1c, an accelerating nozzle, for example with a tapered shape, may be provided. The fluid then enters the oscillation chamber 3. Flow obstacles 6 in the form of islands 6 can be provided in the oscillation chamber 3, depending on the type of oscillator. Alternatively or additionally, return ducts 4 can also be provided which return parts of the fluid flow back toward the inlet 1. The fluid then leaves at the outlet 7 as an oscillating jet 10.

In the embodiment in FIG. 1a, the flow passes straight through the oscillator, i.e. the direction of the flow into the inlet 1 lies within the plane of the oscillating jet 10. In the embodiments in FIGS. 1b and 1c, the flow inlet 1 is from below. The flow is deflected upstream from the actual oscillator.

FIG. 2 shows an angled oscillating nozzle 20 according to an aspect of the invention. In this embodiment, the fluid is conducted into the nozzle 20 via an inlet 1. Although not absolutely necessary, the fluid is then advantageously conducted through an accelerating nozzle 2, into the oscillation chamber 3 via the oscillator inlet 3a. An oscillator which comprises two return ducts 4 is illustrated in FIG. 2. The nozzle in FIG. 2 has a constriction 5 at the point at which the outlet 7 is arranged in the known oscillators. The fluid is then conducted through two ducts 12 which are separated by an island 6. It is very advantageous if the ducts and the island 6 have a high degree of symmetry. The island 6 can in particular have a circular, elliptical, drop-shaped, or similar design. The ducts 12 are rejoined downstream from the island 6 and the fluid subsequently leaves the nozzle 20 via an outlet 7 as an oscillating jet. The region between the constriction 5 and the outlet 7 is referred to as a wake region 11. Together with the oscillator, the wake region 11 here forms the inside of the nozzle 20. In order to ensure that the oscillating jet 10 and the inflow direction do not lie within the same plane, the oscillating nozzle 20 has an angled design. In order not to disrupt the effect of the oscillator, the nozzle 20 is angled by an exit angle inside the wake region. This exit angle can advantageously be between 1° and 90°, in particular between 5° and 45°. An angle of 30° is illustrated by way of example in FIG. 2. In order to prevent the oscillating jet 10 from widening out downstream from the outlet 7, a lip 8 is provided in the nozzle 20 in FIG. 2. It prevents the jet 20 from swerving downward. It can alternatively or additionally be provided that a lip 8 is provided which prevents the jet from swerving upward. The lip 8 or lips 8 is or are not angled or curved in FIG. 2 and instead has or have a straight design. Angling or curving the lips 8 is not necessary in order to deflect the jet because the angling happens earlier inside the nozzle 20. In some cases, it can nevertheless be expedient to provide additional curving or additional angling in the region of the lips 8.

Such an angled oscillating nozzle 20 can be used for a wide range of applications. It is in particular exceptionally well suited for use as an oscillating nozzle 20 in a cleaning device 100 according to an aspect of the invention.

An angled oscillating nozzle 20 according to an aspect of the invention is again shown in FIG. 3 in different views from outside. The course of the internally situated flow spaces is drawn in dashed lines. B1 here designates the inlet width downstream from the accelerating nozzle 2, B2 designates the width of the constriction 5, B3 designates the width of the ducts 12, and B4 the width of the outlet 7. These four widths B1-B4, along with the length of the lip 8, influence the characteristics of the oscillating jet 10. Widening of the jet by 120° within the plane of the jet, which has proved to be very advantageous, can for example be obtained if the widths B1 and B2, i.e. the inlet width and the width of the constriction, are identical. The width of the ducts and the outlet opening can be somewhat wider than the inlet width B1. Particularly advantageous here is the combination:

B2=B1

B3=1.25*B1

B4=1.5*B1

The absolute values of these widths are of course highly dependent on the application and the desired flow rates. For application as an oscillating nozzle 20 in a cleaning device 100 according to an aspect of the invention, the width B1 can be chosen, for example, to be between 1 mm and 5 mm, in particular 2 mm. The geometry of the flow spaces advantageously remains the same over their entire height. In the embodiment in FIG. 2, the height H is chosen to be identical to the inlet width B1. This results in a square cross-section of the inlet 1. The length of the lip 8 can advantageously be at least three times as long as the inlet width B1. This is advantageous for obtaining a jet 20 which is focused in the normal direction. A very advantageous embodiment of the oscillating nozzle thus has the following dimensions:

| B1 | B2 | B3 | B4 | H | Lip |
|---|---|---|---|---|---|
| 2 mm | 2 mm | 2.5 mm | 3 mm | 2 mm | ≥6 mm |

The nozzles 20 shown in FIGS. 2 and 3 each have a thread at their base. This is advantageous for connection to a fluid feed line. Alternatively, this connection can, however, for example, also be effected via a plug connection. In both cases, the nozzles 20 can be replaced easily. Depending on applications, however, other types of connection can also be provided, in particular also non-detachable connections to the fluid feed line.

FIG. 4 shows a portion of a cleaning device 100 according to an aspect of the invention. Such a cleaning device 100 can be used in particular as a cleaning device 100 for a suction roller 130 for a machine for producing or processing a fibrous web. A plurality of cleaning nozzles 120a, 120b are attached to a distribution line 110 which can be designed as a distribution tube 110. They can be supplied with a cleaning fluid such as, for example, spraying water by the distribution line 110. The cleaning fluid can be fed to the distribution line 110 via an individual fluid port 111 or via a plurality of fluid ports 111. The cleaning nozzles are all designed as oscillating nozzles 20 in FIG. 4. It is particularly advantageous if the cleaning nozzles are configured as angled oscillating nozzles 20, for example those described in FIGS. 2 and 3. The embodiment in FIG. 4 has a first quantity 120a and a second quantity 120b of angled cleaning nozzles, wherein the exit angles of the plane of the jet of the first quantity 120a and the second quantity 120b differ from each other. A difference of 5°-10° for the angle is often advantageous. It can thus, for example, be provided that the exit angle of the first quantity 120a is 30° and the exit angle of the second quantity 120b is 35°. It is advantageous if the gap between two neighboring cleaning nozzles is between 150 mm and 350 mm. A cleaning device 100 is illustrated in FIG. 4 in which the gap between the cleaning nozzles varies. The cleaning nozzles are here positioned, for example, in pairs consisting of a nozzle of the first and the second quantity. This can be advantageous, as explained below with the aid of FIG. 5c. Alternatively, the gap between neighboring cleaning nozzles can, however, also be identical, for example 250 mm. However, it can, for example, also be provided that larger gaps between the cleaning nozzles are provided in regions where less contamination is expected, for example at the edge of a suction roller 130, than in the other regions.

A possible method for positioning the cleaning nozzles in a cleaning device according to an aspect of the invention will be described with the aid of FIGS. 5a, 5b, and 5c. The installed situation of a cleaning device 100 in a suction roller 130 is illustrated in FIG. 5. The distribution line 110 here runs parallel to the axis of the suction roller 130, or at least largely parallel to it. The cleaning device 100 comprises, for example, a first quantity 120a and a second quantity 120b of angled oscillating nozzles 20 which are arranged alternately. The respective exit angles are designated θ1 and θ2. The gap between the cleaning device 100 and the shell of the suction roller 130 (measured from the exit point of the jet from the nozzle) is 1_{d}. FIG. 5b shows a plan view of a device as in FIG. 5a. The oscillation angle θW, i.e. the angle covered by the oscillating jet 10 when it oscillates, can be seen here. This oscillation angle can lie, for example, between 90° and 170°. As can be seen in FIG. 5b, the nozzles 20 can be arranged such that, in the case of neighboring nozzles, the regions in which the jets 10 oscillate overlap. It is then advantageous here if respective neighboring nozzles 20, 120a, 120b have different exit angles θ1, θ2. The planes of the jets of neighboring nozzles are consequently situated in space such that the jets cannot touch and consequently disrupt each other. As can be seen in FIG. 5a, the jet of the first quantity 120a strikes the shell of the suction roller 130 above the jet of the second quantity 120b. FIG. 5c illustrates why the overlapping of neighboring jet ranges according to an aspect of the invention is not only readily possible but also advantageous. The graph shows the volume flow of fluid of four neighboring oscillating nozzles 20. Visible here is a typical “M profile”, i.e. less fluid per unit time strikes the suction roller 130 at the center of the range covered than toward the edges. This is generally typical for oscillators. As described, the distribution of the fluid using a wake region 11 can be homogenized, as a result of which wider oscillation angles θW and larger ranges b_{S} covered become possible. As a result, the cleaning device 100 can be formed with fewer nozzles 20. It can be seen that the nozzles of the first quantity 120a are positioned such that their jets do not touch each other. The nozzles of the second quantity 120b can then be positioned such that the regions with a high volume flow of the fluid are where there is a lower volume flow for the nozzles of the first quantity 120a, and vice versa. It can thus be achieved that fluid is applied evenly widthwise at the center of the shell of the suction roller 130, and also other moving surfaces which need to be cleaned or moistened. The value b_{S} in FIG. 5c moreover describes the width of the region covered by the oscillating jet 10. With the aid of the oscillation angle θW and the gap between the oscillating nozzle 20 and the shell of the suction roller 130, this width is determined by

$${b}_{S} = 2 {l}_{d} tan \frac{θ W}{2}$$

It has been shown to be advantageous to position the cleaning nozzles, as illustrated in FIG. 4, in pairs consisting of a nozzle of the first and the second quantity. These two nozzles of a pair have the gap 1_{A}, whilst the gap to the first nozzle of the next pair is l_{B}. Preferably, l_{A}=0.25 b_{S} and l_{B}=0.75 b_{S}. Particularly homogeneous cleaning of the suction roller 130 results. More generally, the gaps should be chosen to be:

l_{A}∈[0.2.0.3]b_{S}; l_{B}∈[0.7.0.8]b_{S}

### LIST OF REFERENCE SYMBOLS

1 inlet

2 accelerating nozzle

3 oscillation chamber

3a oscillator inlet

4 return ducts

5 constriction

6 island

7 outlet opening

8 lip

9 exit angle

10 oscillating jet

11 wake region

12 duct

15 flow chamber

20 oscillating nozzle

100 cleaning device

110 distribution line

111 fluid port

120a first quantity

120b second quantity

130 suction roller

B1 inlet width

B2 width of the constriction

B3 width of the ducts

B4 width of the outlet opening

H height of the flow chamber

θ1, θ2 exit angle

θW oscillation angle

1-14. (canceled)

15. A cleaning device or a cleaning device for a suction roller for a machine for producing or processing a fibrous web, the cleaning device comprising:
a distribution line; and
a plurality of cleaning nozzles to be supplied with a cleaning fluid by said distribution line;
at least one or all of said cleaning nozzles being oscillating nozzles configured as fluid oscillators generating a fluid jet oscillating in a jet plane.

16. The cleaning device according to claim 15, wherein said oscillating nozzles include a first quantity and a second quantity of oscillating nozzles, said jet planes of said fluid jets of said first and second quantities of oscillating nozzles define exit angles differing from each other, and said exit angles are angles which said jet planes enclose with the vertical.

17. The cleaning device according to claim 16, wherein said oscillating nozzles of said first and second quantities are disposed alternatingly.

18. The cleaning device according to claim 15, wherein at least some or all of said oscillating nozzles have an angled shape deflecting said jet plane inside said oscillating nozzles.

19. The cleaning device according to claim 18, wherein said jet plane is deflected by an angle of between 1° and 90°.

20. The cleaning device according to claim 18, wherein said jet plane is deflected by an angle of between 5° and 45°.

21. The cleaning device according to claim 16, wherein said exit angles of said jet planes of said first quantity and said second quantity differ by more than 2°.

22. The cleaning device according to claim 16, wherein said exit angles of said jet planes of said first quantity and said second quantity differ by between 5° and 25°.

23. The cleaning device according to claim 15, which further comprises a detachable connection, a screw connection or a plug connection connecting said cleaning nozzles to said distribution line.

24. The cleaning device according to claim 15, wherein said cleaning nozzles are mutually spaced apart by a respective gap of less than 500 mm.

25. The cleaning device according to claim 15, wherein said cleaning nozzles are mutually spaced apart by a respective gap of between 150 mm and 350 mm.

26. The cleaning device according to claim 15, wherein said oscillating fluid jet covers an oscillation angle within a range of between 90° and 170°.

27. The cleaning device according to claim 15, wherein said oscillating fluid jet covers an oscillation angle of 120°.

28. The cleaning device according to claim 15, wherein at least one or all of said oscillating nozzles are completely or partially made of a metal or a plastic.

29. A suction roller for a machine for producing or processing a fibrous web, the suction roller comprising at least one cleaning device according to claim 15.

30. The suction roller according to claim 29, wherein the at least one cleaning device is disposed inside the suction roller.

31. A method for cleaning a suction roller, the method comprising:
providing a suction roller according to claim 29;
applying a fluid or spraying water to the at least one cleaning device; and
delivering the fluid or spraying water at a pressure of less than 40 bar.

32. The method according to claim 31, which further comprises delivering the fluid or spraying water at a pressure of less than 10 bar.

33. The method according to claim 32, which further comprises delivering the fluid or spraying water at a pressure of between 1 and 5 bar.

34. The method according to claim 31, which further comprises delivering the fluid or spraying water at less than 20 l/min/m for cleaning.

35. The method according to claim 31, which further comprises delivering the fluid or spraying water at between 9 l/min/m and 11 l/min/m for cleaning.
